(19) United States
(12) Patent Application Publication
(10) Pub. No.: US 2026/0298333 A1
(43) Pub. Date: Oct. 1, 2026

(54) SHIFT DEVICE

(71) Applicant: KABUSHIKI KAISHA TOKAI-RIKA-DENKI-SEISAKUSHO, Niwa-gun, Aichi (JP)

(72) Inventor: Hiroki ONO, Niwa-gun, Aichi (JP)

(73) Assignee: KABUSHIKI KAISHA TOKAI-RIKA-DENKI-SEISAKUSHO, Niwa-gun, Aichi (JP)

(21) Appl. No.: 19/474,077

(22) PCT Filed: Apr. 5, 2024
(86) PCT No.: PCT/JP2024/014060

§ 371 Date: Oct. 9, 2025

(30) Foreign Application Priority Data
Apr. 21, 2023 (JP) 2023-070475

(51) Int. Cl. F16H 59/10; B60K 20/04; G01D 5/14

(52) U.S. Cl. CPC F16H 59/105; B60K 20/04; G01D 5/14

(57) ABSTRACT

A shift device includes: a shift body having an operation rod that can rotate with respect to a rotation axis; and a sensor substrate disposed at one side, in a rotating direction of the operation rod, with respect to the rotation axis, and having a sensor that detects a rotational position of the operation rod.

### TECHNICAL FIELD

The present disclosure relates to a shift device.

### BACKGROUND ART

There is known a shift device that includes a shift body having an operation rod rotatable with respect to a rotation axis (see, for example, Chinese Utility Model No. 212587409).

Chinese Utility Model No. 212587409 discloses a technique in which a circuit board is provided so as to span over, in a swinging direction, the rotation axis of an operation rod that swings.

By the way, it is preferable to make such a shift device compact.

### SUMMARY OF INVENTION

### Technical Problem

The present disclosure provides a shift device that can be made compact.

### Solution to Problem

A shift device of a first aspect of the present disclosure includes: a shift body having an operation rod that can rotate with respect to a rotation axis; and a sensor substrate disposed at one side, in a rotating direction of the operation rod, with respect to the rotation axis, and having a sensor that detects a rotational position of the operation rod.

In a shift device of a second aspect of the present disclosure, in the shift device of the first aspect of the present disclosure, the sensor substrate is disposed further toward an inner side than an outer side portion of the shift body, in an axial direction of the rotation axis.

In a shift device of a third aspect of the present disclosure, in the shift device of the first aspect or the second aspect of the present disclosure, at least a portion of the sensor substrate is disposed in a concave portion, which is recessed in an axial direction of the rotation axis, of the shift body.

A shift device of a fourth aspect of the present disclosure includes, in the shift device of any one of the first aspect through the third aspect of the present disclosure, a rotating body connected to the shift body by a gear, wherein the sensor is disposed at a position at which the sensor can detect a rotational position of the rotating body.

In a shift device of a fifth aspect of the present disclosure, in the shift device of any one of the first aspect through the fourth aspect of the present disclosure, the sensor substrate is disposed so as to avoid a rotation range of the operation rod as seen from an axial direction of the rotation axis.

In a shift device of a sixth aspect of the present disclosure, in the shift device of the fifth aspect of the present disclosure, the sensor substrate is formed in a shape of a plate that extends in the rotating direction, with the axial direction of the rotation axis being a plate thickness direction of the sensor substrate, and, as seen from the axial direction of the rotation axis, the sensor substrate is disposed so as to avoid the rotation range of the operation rod due to at least one notch being formed in a portion, which is at a rotation axis side, of the sensor substrate.

In a shift device of a seventh aspect of the present disclosure, in the shift device of the fifth aspect of the present disclosure, the sensor substrate is formed in a shape of a plate that extends in the rotating direction, with the axial direction of the rotation axis being a plate thickness direction of the sensor substrate, and, as seen from the axial direction of the rotation axis, the sensor substrate is disposed so as to avoid the rotation range of the operation rod due to a portion, which is at a rotation axis side, of the sensor substrate being formed in a tapered shape that is inclined with respect to the rotation axis.

### Advantageous Effects of Invention

In the shift device of the first aspect of the present disclosure, by providing the sensor substrate that is disposed at one side, in the rotating direction of the operation rod, with respect to the rotation axis and that includes the sensor that detects the rotational position of the operation rod, the sensor substrate is not disposed so as to span over the rotation axis. Therefore, the sensor substrate can be disposed toward the inner side of the shift device in the axial direction of the rotation axis. As a result, the shift device can be made to be compact in the axial direction of the rotation axis.

In the shift device of the second aspect of the present disclosure, due to the sensor substrate being disposed further toward the inner side than the outer side portion of the shift body in the axial direction of the rotation axis, the sensor substrate is not disposed further toward the outer side than the outer side portion of the shift body in the axial direction of the rotation axis. Therefore, the shift device can be made to be compact in the axial direction of the rotation axis.

In the shift device of the third aspect of the present disclosure, due to at least a portion of the sensor substrate being disposed in the concave portion, which is recessed in the axial direction of the rotation axis, of the shift body, the sensor substrate is disposed near the central portion of the shift body in the axial direction of the rotation axis. Therefore, the shift device can be made to be compact in the axial direction of the rotation axis.

In the shift device of the fourth aspect of the present disclosure, due to the magnet sensor being disposed at a position at which it can detect the rotational position of the rotating body, the shift device, which includes the sensor substrate having the sensor that can detect the rotational position of the rotating body, can be made to be compact in the axial direction of the rotation axis.

In the shift device of the fifth aspect of the present disclosure, due to the sensor substrate being disposed so as to avoid the rotation range of the operation rod as seen from the axial direction of the rotation axis, there is no need for the sensor substrate to be disposed further toward the outer side than the operation rod in the axial direction of the rotation axis. Therefore, the shift device can be made to be compact in the axial direction of the rotation axis.

In the shift device of the sixth aspect of the present disclosure, due to the sensor substrate being disposed so as to avoid the rotation range of the operation rod as seen from the axial direction of the rotation axis, there is no need for the sensor substrate to be disposed further toward the outer side than the operation rod in the axial direction of the rotation axis. Therefore, the shift device can be made to be compact in the axial direction of the rotation axis.

In the shift device of the seventh aspect of the present disclosure, due to the sensor substrate being disposed so as to avoid the rotation range of the operation rod as seen from the axial direction of the rotation axis, there is no need for the sensor substrate to be disposed further toward the outer side than the operation rod in the axial direction of the rotation axis. Therefore, the shift device can be made to be compact in the axial direction of the rotation axis.

### BRIEF DESCRIPTION OF DRAWINGS

FIG. 1 is a perspective view illustrating a shift device relating to an embodiment.

FIG. 2 is an exploded perspective view illustrating the shift device relating to the embodiment.

FIG. 3 is a perspective view illustrating a shift body and a sensor substrate relating to the embodiment.

FIG. 4 is a cross-sectional view illustrating the shift device relating to the embodiment, and illustrates the B-B cross-section of FIG. 1.

FIG. 5 is a cross-sectional view illustrating the shift device relating to the embodiment, and illustrates the A-A cross-section of FIG. 1.

FIG. 6 is a cross-sectional view illustrating the shift device relating to the embodiment, and illustrates a state in which an operation rod is tilted forward.

### DESCRIPTION OF EMBODIMENTS

A shift device relating to an embodiment is described hereinafter with reference to the drawings. The embodiment describes an example in which a shift device 10 is a shift-by-wire type shift device for a vehicle. Note that, in the respective drawings, arrow D indicates a vertical direction D of a shift body, arrow E indicates a front-rear direction E of the shift device, and arrow F indicates a transverse direction F of the shift device.

### Structure of Shift Device

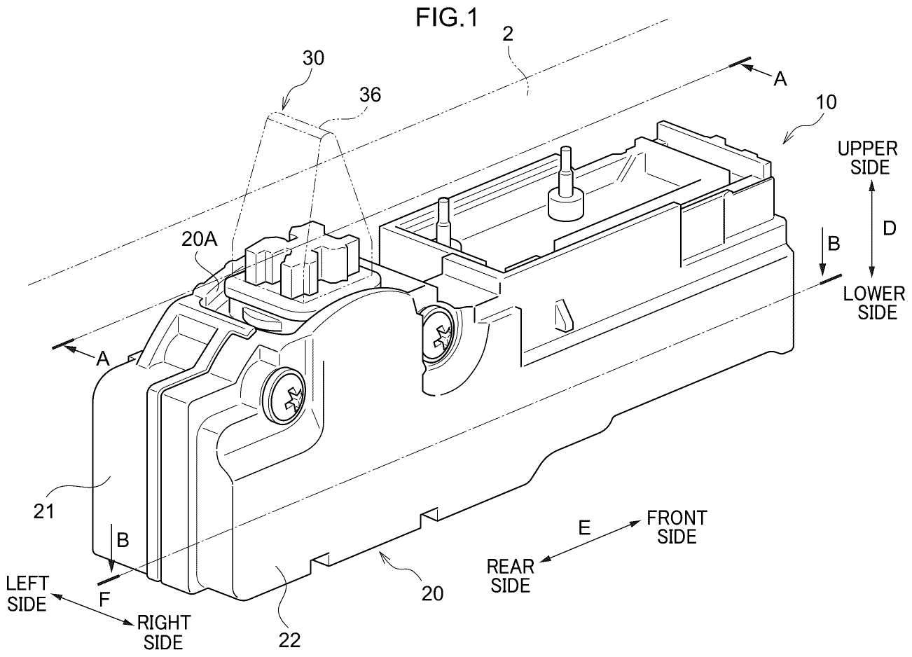

As illustrated in FIG. 1, the shift device 10 is, for example, disposed at a center console 2 provided between the driver's seat and the front passenger's seat within a vehicle passenger compartment. The shift position can be switched by the driver who is seated in the driver's seat operating the shift device 10.

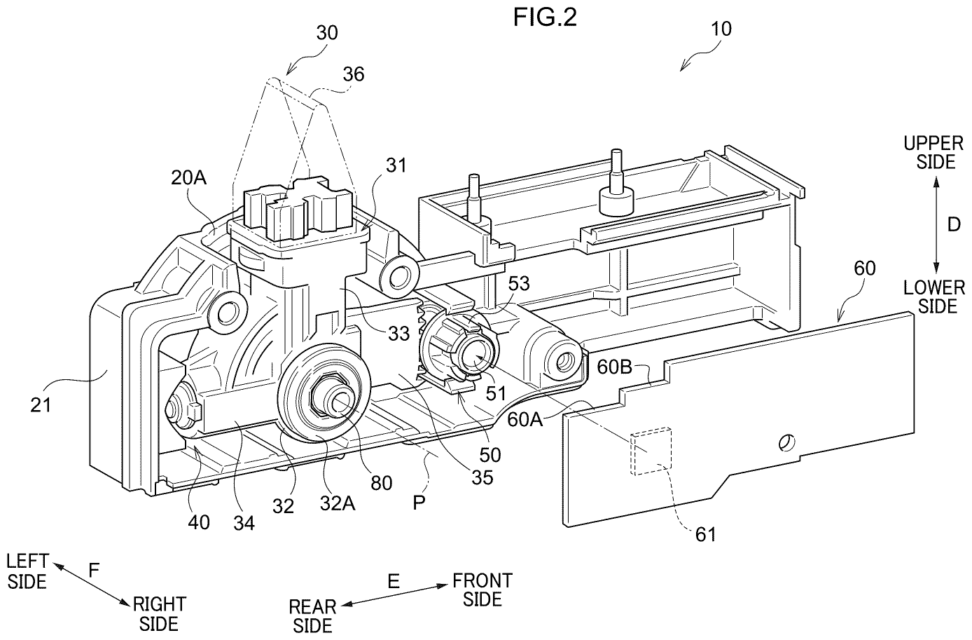

As illustrated in FIG. 1 and FIG. 2, the shift device 10 includes a housing 20, a shift body 30, an urging mechanism 40, a position detecting mechanism 50 and a sensor substrate 60.

### Housing 20

The housing 20 is formed in the shape of a rectangular box that extends in the front-rear direction E by a first housing 21 and a second housing 22. Opening portion 20A that opens upward is formed in the upper portion of the rear portion in the front-rear direction E of the housing 20. A knob 36 of the shift body 30 projects out to the exterior of the housing 20 from the opening portion 20A of the housing 20.

As illustrated in FIG. 2, a portion of the shift body 30, the urging mechanism 40, the position detecting mechanism 50 and the sensor substrate 60 are provided at the inner side of the housing 20.

### Shift Body 30

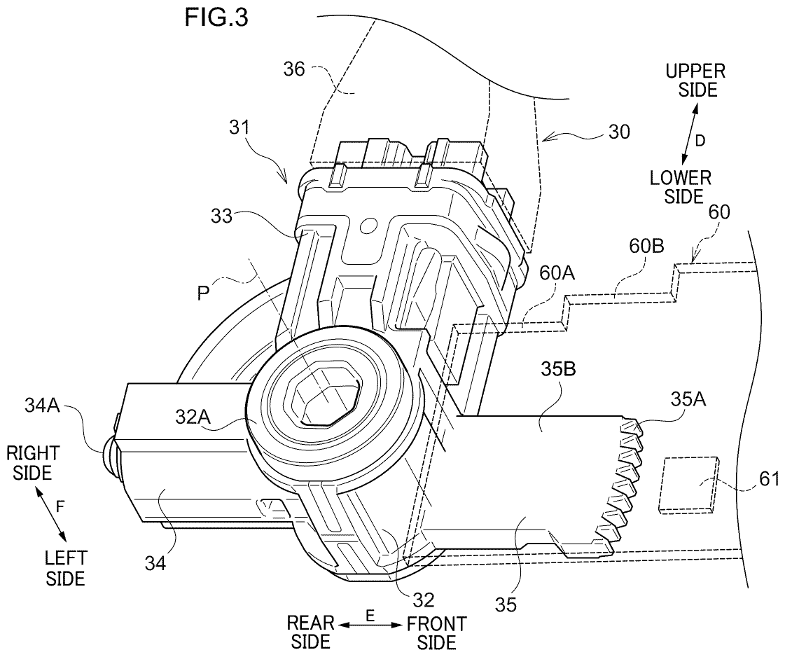

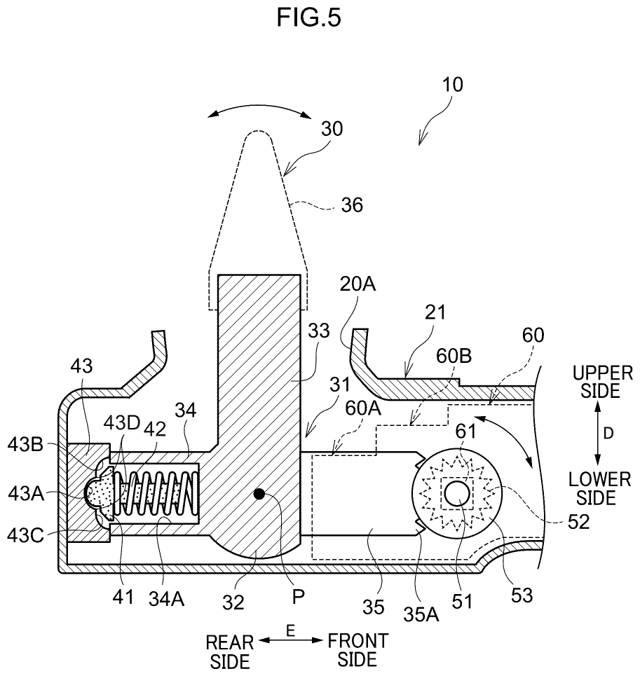

As illustrated in FIG. 3 and FIG. 5, the shift body 30 includes a main body portion 31 and the knob 36.

### Main Body Portion 31

The main body portion 31 includes a shaft body 32, an operation rod 33 provided so as to project out upward from the shaft body 32, a first projecting portion 34 provided so as to project out rearward from the shaft body 32, and a second projecting portion 35 provided so as to project out forward from the shaft body 32.

### Shaft Body 32

The shaft body 32 is formed substantially in the shape of a cylinder that extends in the transverse direction F. The shaft body 32 is structured so as to be able to rotate with respect to supporting shaft 80 (see FIG. 2) that is mounted to the housing 20. The operation rod 33 can thereby rotate around rotation axis P that extends in the transverse direction F. In other words, the operation rod 33 can rotate in the front-rear direction E.

### Operation Rod 33

The operation rod 33 is formed in the shape of a pillar whose cross-section is substantially rectangular and that extends upward from the shaft body 32. The operation rod 33 passes-through the opening portion 20A of the housing 20. The knob 36 is provided at the distal end of the operation rod 33, and the knob 36 is exposed to the exterior of the housing 20.

### First Projecting Portion 34

The first projecting portion 34 is formed in the shape of a pillar whose cross-section is rectangular and that extends rearward from the shaft body 32. In the rotating direction of the operation rod 33, the first projecting portion 34 is disposed at the rear side with respect to the shaft body 32. The first projecting portion 34 projects out in a direction orthogonal to the vertical direction D of the shift body 30. A hole 34A with a bottom, which extends in the front-rear direction E and has a bottom surface, is formed in the distal end surface (the rear end surface) of the first projecting portion 34. A click pin 41 and a click spring (compression coil spring) 42 are inserted in the hole 34A with a bottom.

The distal end surface (the rear end surface) of the click pin 41 is formed in a spherical shape. The click pin 41 is urged by the click spring 42 in a direction of projecting out from the distal end surface of the first projecting portion 34.

An abutment member 43 that the distal end surface of the click pin 41 abuts is mounted to the housing 20. A first abutment hole 43A, a second abutment hole 43B provided above the first abutment hole 43A, and a third abutment hole 43C provided beneath the first abutment hole 43A are provided in the abutment member 43.

Click ridges 43D formed to project out forward are formed between the first abutment hole 43A and the second abutment hole 43B, and between the first abutment hole 43A and the third abutment hole 43C.

The click pin 41, the click spring 42 and the abutment member 43 structure the urging mechanism 40 that provides a clicking sensation to the operation of the operation rod 33.

### Second Projecting Portion 35

As illustrated in FIG. 3 and FIG. 5, the second projecting portion 35 is formed in the shape of a pillar whose cross-section is rectangular and that extends forward from the shaft body 32. In the rotating direction of the operation rod 33, the second projecting portion 35 is disposed at the front side with respect to the shaft body 32. The first projecting portion 34 and the second projecting portion 35 project out toward mutually opposite sides with the shaft body 32 therebetween. The second projecting portion 35 projects out in a direction orthogonal to the vertical direction D of the shift body 30.

A concave portion 35B that is recessed toward the left side in the transverse direction F is formed in the second projecting portion 35. In other words, a concave portion that is recessed in the axial direction of the rotation axis P is formed in the second projecting portion 35. A gear 35A having plural teeth is formed in the distal end surface (the front end surface) of the second projecting portion 35.

A holder 53 that rotatably holds a magnet 51 serving as a rotating body is mounted to the housing 20. The magnet 51 is formed in a cylindrical shape for example, and different poles are magnetized in the peripheral direction. In other words, at the magnet 51, an N pole is magnetized at a radial direction one side, and an S pole is magnetized at the radial direction another side. A gear 52 having plural teeth is mounted to the magnet 51. The gear 35A of the second projecting portion 35 meshes together with the gear 52 mounted to the magnet 51. When the operation rod 33 is operated, motive power is transmitted from the gear 35A to the gear 52, and the magnet 51 rotates. Namely, the magnet 51 is connected to the shift body 30 by the gear 35A and the gear 52.

### Sensor Substrate 60

As illustrated in FIG. 2, the sensor substrate 60 is disposed at the right side in the transverse direction F of the magnet 51, and is mounted to the housing 20. As illustrated in FIG. 5, the sensor substrate 60 is disposed at the front side in the front-rear direction E with respect to the rotation axis P. In other words, the sensor substrate 60 is disposed at the front side, in the rotating direction of the operation rod 33, with respect to the rotation axis P.

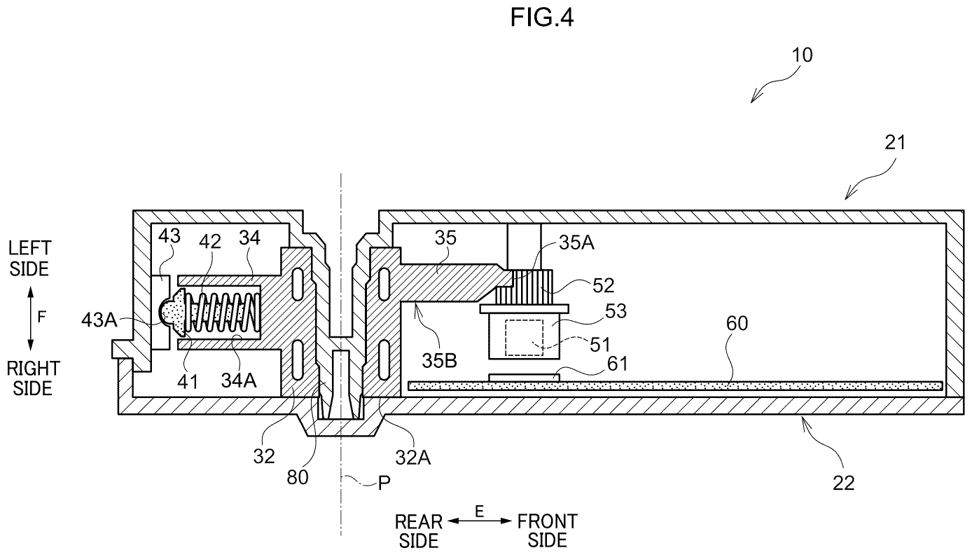

As illustrated in FIG. 3 and FIG. 4, the sensor substrate 60 is disposed further toward the inner side in the transverse direction F than an outermost surface 32A (an example of the outermost portion) that is at the outermost side of the shaft body 32 in the transverse direction F. In other words, the sensor substrate 60 is disposed further toward the inner side than the outer side portion of the shift body 30 in the axial direction of the rotation axis P. The rear end portion of the sensor substrate 60 is disposed so as to be accommodated in the concave portion 35B that is recessed in the axial direction of the rotation axis P.

As illustrated in FIG. 2 and FIG. 5, the sensor substrate 60 is formed in the shape of a plate that is substantially rectangular and extends in the front-rear direction E, with the transverse direction F being the plate thickness direction thereof. A first notch portion 60A and a second notch portion 60B are formed in the upper portion of the rear portion of the sensor substrate 60 (an example of the one portion at the rotation axis side).

The first notch portion 60A is formed as a rectangular notch in the upper portion of the rear portion of the sensor substrate 60. The second notch portion 60B is formed in the upper portion of the rear portion of the sensor substrate 60, at further toward the front side than the first notch portion 60A. The first notch portion 60A and the second notch portion 60B are continuous, and are formed in the shape of steps that become higher from rear to front.

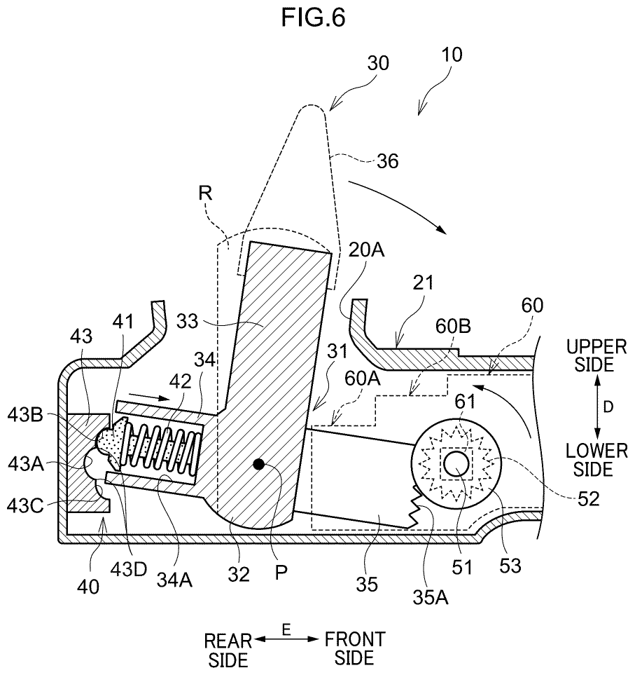

As illustrated in FIG. 6, as seen from the transverse direction F, the sensor substrate 60 is disposed so as to avoid rotation range R of the operation rod. In other words, as seen from the axial direction of the rotation axis P, the sensor substrate 60 is disposed so as to avoid the rotation range R of the operation rod 33.

As illustrated in FIG. 2 and FIG. 5, a magnet sensor 61 serving as a sensor is provided at the sensor substrate 60. The magnet sensor 61 is disposed at a position at which it can detect the rotational position of the magnet 51. The magnet sensor 61 detects the shift position of the operation rod 33 by detecting the direction of the magnetic field produced by the magnet 51. In other words, the magnet sensor 61 detects the rotational position of the operation rod 33.

The gear 35A, the magnet 51, the gear 52 and the magnet sensor 61 structure the position detecting mechanism 50 that detects the shift position of the operation rod 33.

### Operation of Shift Device

As illustrated in FIG. 5, in the state in which the operation rod 33 is at a home position, the distal end surface of the click pin 41 is fit with the first abutment hole 43A due to the urging force of the click spring 42.

As illustrated in FIG. 6, when the knob 36 is operated and the operation rod 33 is tilted forward from the home position, the first projecting portion 34 rotates upward with the rotation axis P being the center of rotation. At this time, the click pin 41 rides up over the click ridge 43D and moves into the second abutment hole 43B. Due to the click pin 41 riding up over the click ridge 43D, the operator of the knob 36 can obtain a clicking sensation.

Further, when the knob 36 is operated and the operation rod 33 is tilted forward from the home position, the second projecting portion 35 rotates downward with the rotation axis P being the center of rotation. At this time, the downward motive power of the second projecting portion 35 is transmitted to the gear 35A of the second projecting portion 35 and to the gear 52, and the magnet 51 rotates. Then, due to the magnet sensor 61 detecting the direction of the magnetic field produced by the magnet 51, the magnet sensor 61 detects the shift position of the operation rod 33.

When the driver releases their hold on the knob 36, due to the urging force of the click spring 42, the first projecting portion 34 moves from the second abutment hole 43B to the first abutment hole 43A with the rotation axis P being the center of rotation, and the operation rod 33 returns to the home position from the state of being tilted forward.

When the knob 36 is operated and the operation rod 33 is tilted rearward from the home position, the first projecting portion 34 rotates downward with the rotation axis P being the center of rotation. At this time, the click pin 41 rides up over the click ridge 43D and moves into the third abutment hole 43C. Due to the click pin 41 riding up over the click ridge 43D, the operator of the knob 36 can obtain a clicking sensation.

Further, when the knob 36 is operated and the operation rod 33 is tilted rearward from the home position, the second projecting portion 35 rotates upward with the rotation axis P being the center of rotation. At this time, the upward motive power of the second projecting portion 35 is transmitted to the gear 35A of the second projecting portion 35 and to the gear 52, and the magnet 51 rotates. Then, due to the magnet sensor 61 detecting the direction of the magnetic field produced by the magnet 51, the magnet sensor 61 detects the shift position of the operation rod 33.

When the driver releases their hold on the knob 36, due to the urging force of the click spring 42, the first projecting portion 34 moves from the third abutment hole 43C to the first abutment hole 43A with the rotation axis P being the center of rotation, and the operation rod 33 returns to the home position from the state of being tilted rearward.

### Effects

The shift device 10 of the embodiment includes the shift body 30, which includes the operation rod 33 that can rotate with respect to the rotation axis P, and the sensor substrate 60 that is disposed at the front side, in the rotating direction of the operation rod 33, with respect to the rotation axis P and that includes the magnet sensor 61 that detects the rotational position of the operation rod 33 (see FIG. 5).

By the way, if the sensor substrate 60 is disposed so as to span over the rotation axis P, the sensor substrate 60 is disposed toward the outer side of the shift device 10 in the axial direction of the rotation axis P. Therefore, there is the problem that the shift device 10 cannot be made to be compact in the axial direction of the rotation axis P.

By providing the sensor substrate 60 that is disposed at the front side, in the rotating direction of the operation rod 33, with respect to the rotation axis P and that includes the magnet sensor 61 that detects the rotational position of the operation rod 33, the sensor substrate 60 is not disposed so as to span over the rotation axis P. Therefore, the sensor substrate 60 can be disposed toward the inner side of the shift device 10 in the axial direction of the rotation axis P. As a result, the shift device 10 can be made to be compact in the axial direction of the rotation axis P.

In the shift device 10 of the embodiment, the sensor substrate 60 is disposed further toward the inner side than the outermost surface 32A of the shift body 30 in the axial direction of the rotation axis P (see FIG. 3).

Due to the sensor substrate 60 being disposed further toward the inner side than the outermost surface 32A of the shift body 30 in the axial direction of the rotation axis P, the sensor substrate 60 is not disposed further toward the outer side than the outermost surface 32A of the shift body 30 in the axial direction of the rotation axis P. Therefore, the shift device 10 can be made to be compact in the axial direction of the rotation axis P.

In the shift device 10 of the embodiment, the rear end of the sensor substrate 60 in the front-rear direction E is disposed in the concave portion 35B, which is recessed in the axial direction of the rotation axis P, of the shift body 30 (see FIG. 3).

Due to the rear end of the sensor substrate 60 in the front-rear direction E being disposed in the concave portion 35B, which is recessed in the axial direction of the rotation axis P, of the shift body 30, the sensor substrate 60 is disposed near the central portion of the shift body 30 in the axial direction of the rotation axis P. Therefore, the shift device 10 can be made to be compact in the axial direction of the rotation axis P.

The shift device 10 of the embodiment includes the magnet 51 that is connected to the shift body 30 by the gear 52, and the magnet sensor 61 is disposed at a position at which it can detect the rotational position of the magnet 51 (see FIG. 5).

Due to the magnet sensor 61 being disposed at a position at which it can detect the rotational position of the magnet 51, the shift device 10, which includes the sensor substrate 60 having the magnet sensor 61 that can detect the rotational position of the magnet 51, can be made to be compact in the axial direction of the rotation axis P.

In the shift device 10 of the embodiment, the sensor substrate 60 is disposed so as to avoid the rotation range R of the operation rod 33 as seen from the axial direction of the rotation axis P (see FIG. 6).

By the way, if the sensor substrate 60 is disposed in the rotation range R of the operation rod 33 as seen from the axial direction of the rotation axis P, the sensor substrate 60 must be disposed so as to avoid the rotation range R of the operation rod 33 in the axial direction of the rotation axis P. Therefore, the sensor substrate 60 is disposed further toward the outer side than the operation rod 33 in the axial direction of the rotation axis P. As a result, there is the problem that the shift device 10 cannot be made to be compact in the axial direction of the rotation axis P.

Due to the sensor substrate 60 being disposed so as to avoid the rotation range R of the operation rod 33 as seen from the axial direction of the rotation axis P, there is no need to dispose the sensor substrate 60 further toward the outer side than the operation rod 33 in the axial direction of the rotation axis P. Therefore, the shift device 10 can be made to be compact in the axial direction of the rotation axis P.

The shift device of the present disclosure has been described above on the basis of the above-described embodiment. However, the specific structure is not limited to this embodiment, and changes in design and the like are permitted provided that they do not depart from the gist of the inventions relating to the respective claims of the Claims.

The above embodiment illustrates an example that is structured such that the rotation range R of the operation rod 33 is avoided due to the first notch portion 60A and the second notch portion 60B being formed in the upper portion of the rear portion of the sensor substrate 60. However, the number of notches is not limited to this, and may be one or may be three or more. The shapes of the notches may be shapes other than rectangular. Further, the rotation range R of the operation rod 33 may be avoided by making the upper portion of the rear portion of the sensor substrate be a tapered shape that is inclined with respect to the front-rear direction E.

The above embodiment illustrates an example in which the sensor substrate 60 is disposed at the front side, in the front-rear direction E, with respect to the rotation axis P. However, the sensor substrate 60 may be disposed at the rear side, in the front-rear direction E, with respect to the rotation axis P.

The above embodiment illustrates an example in which the two projecting portions that are the first projecting portion 34 and the second projecting portion 35 are provided as the projecting portions that project out from the shaft body 32. However, there may be one, or there may be three or more, of the projecting portions that project out from the shaft body.

The above embodiment illustrates an example in which the shift device 10 is a momentary-type shift device in which the operation rod 33 returns to the home position by itself when the driver releases their hold on the knob 36. However, the shift device can also be made to be a stationary-type shift device in which the operation rod 33 is maintained at the shift position due to the knob being operated.

The above embodiment illustrates an example in which the holder 53 that holds the magnet 51 rotatably is mounted to the housing 20. However, the magnet may be provided at the second projecting portion.

The above embodiment illustrates an example in which the shift device 10 is disposed at the center console 2. However, the shift device can be disposed at another part within the vehicle passenger compartment such as the instrument panel, the column cover, or a door trim.

The disclosure of Japanese Patent Application No. 2023-070475 filed on Apr. 21, 2023 is, in its entirety, incorporated by reference into the present specification.

All publications, patent applications, and technical standards mentioned in the present specification are incorporated by reference into the present specification to the same extent as if such individual publication, patent application, or technical standard was specifically and individually indicated to be incorporated by reference.

1. A shift device comprising:
a shift body having an operation rod that can rotate with respect to a rotation axis; and
a sensor substrate disposed at one side, in a rotating direction of the operation rod, with respect to the rotation axis, and having a sensor that detects a rotational position of the operation rod.

2. The shift device of claim 1, wherein the sensor substrate is disposed further toward an inner side than an outer side portion of the shift body, in an axial direction of the rotation axis.

3. The shift device of claim 1, wherein at least a portion of the sensor substrate is disposed in a concave portion, which is recessed in an axial direction of the rotation axis, of the shift body.

4. The shift device of claim 1, comprising a rotating body connected to the shift body by a gear,
wherein the sensor is disposed at a position at which the sensor can detect a rotational position of the rotating body.

5. The shift device of claim 1, wherein the sensor substrate is disposed so as to avoid a rotation range of the operation rod as seen from an axial direction of the rotation axis.

6. The shift device of claim 5, wherein:
the sensor substrate is formed in a shape of a plate that extends in the rotating direction, with the axial direction of the rotation axis being a plate thickness direction of the sensor substrate, and
as seen from the axial direction of the rotation axis, the sensor substrate is disposed so as to avoid the rotation range of the operation rod due to at least one notch being formed in a portion, which is at a rotation axis side, of the sensor substrate.

7. The shift device of claim 5, wherein:
the sensor substrate is formed in a shape of a plate that extends in the rotating direction, with the axial direction of the rotation axis being a plate thickness direction of the sensor substrate, and
as seen from the axial direction of the rotation axis, the sensor substrate is disposed so as to avoid the rotation range of the operation rod due to a portion, which is at a rotation axis side, of the sensor substrate being formed in a tapered shape that is inclined with respect to the rotation axis.
